(19) United States
(12) Patent Application Publication
(10) Pub. No.: US 2026/0267263 A1
(43) Pub. Date: Sep. 10, 2026

(54) SHEET CONVEYANCE APPARATUS AND IMAGE FORMING APPARATUS

(71) Applicant: CANON KABUSHIKI KAISHA, Tokyo (JP)

(72) Inventor: KEITA NAKAJIMA, Shizuoka (JP)

(21) Appl. No.: 19/542,917

(22) Filed: Feb. 18, 2026

(30) Foreign Application Priority Data
Mar. 5, 2025 (JP) 2025-034652

(51) Int. Cl. G03G 15/23; B65H 85/00; G03G 15/00; G03G 15/20

(52) U.S. Cl. CPC G03G 15/234; B65H 85/00; G03G 15/2017; G03G 15/2064; G03G 15/6573; G03G 2215/00586; G03G 2215/00599

(57) ABSTRACT

A sheet conveyance apparatus includes first and second conveyance units configured to convey a sheet, first and second conveyance paths configured to guide the sheet, a drive unit configured to drive the first and second conveyance units, and a control unit configured to control the drive unit. In a case of conveying a preceding sheet from the second conveyance unit to the second conveyance path and conveying a succeeding sheet to the first conveyance path, the control unit is configured to control the drive unit such that a leading edge of the succeeding sheet reaches the first connection portion in a state in which a trailing edge of the preceding sheet is positioned between the first connection portion and the second conveyance unit.

### BACKGROUND

### FIELD OF THE TECHNOLOGY

This disclosure relates to a sheet conveyance apparatus that conveys a sheet, and an image forming apparatus.

### DESCRIPTION OF THE RELATED ART

An image forming apparatus including a paper reversing mechanism is proposed that feeds a sheet into a reverse path from a leading edge of the sheet and then discharges the sheet in a switchback manner with a trailing edge of the sheet becoming the leading edge (refer to Japanese Patent Laid-Open No. 2003-192205). In the image forming apparatus described in Japanese Patent Laid-Open No. 2003-192205, the paper reversing mechanism includes a reverse roller disposed in an upper direction, which has a notched portion, and a driven roller disposed in a lower direction. Then, when a succeeding sheet is fed into the paper reversing mechanism, the notched portion of the reverse roller is directed downward to establish an open state; thereby, a preceding sheet is allowed to overlap a portion of the succeeding sheet.

However, image forming apparatuses, such as the image forming apparatus described in Japanese Patent Laid-Open No. 2003-192205, that bring paper reversing mechanisms into the open state do not nip the leading edge of the succeeding sheet; therefore, stability during the conveyance of the succeeding sheet is diminished. On the other hand, for example, in a case where duplex conveyance paths are shortened to miniaturize the image forming apparatuses, alternate sheet feeding that performs image formation on the succeeding sheet during the re-conveyance of the preceding sheet is eliminated, so that productivity for duplex printing is diminished.

### SUMMARY

Accordingly, this disclosure aims to provide a sheet conveyance apparatus and an image forming apparatus that enable stabilized sheet conveyance and enhanced productivity for duplex printing.

According to a first aspect of the present disclosure, a sheet conveyance apparatus includes a first conveyance unit configured to convey a sheet, a second conveyance unit disposed downstream of the first conveyance unit in a sheet conveyance direction by the first conveyance unit, the second conveyance unit including a first roller and a second roller, the first roller and the second roller being configured to convey the sheet while nipping the sheet, the second conveyance unit being configured to convey the sheet in a first conveyance direction and subsequently convey the sheet in a second conveyance direction opposite to the first conveyance direction in a state in which the first roller and the second roller are in contact with the sheet, a first conveyance path configured to guide the sheet that is conveyed from the first conveyance unit to the second conveyance unit, a second conveyance path connected to the first conveyance path at a first connection portion, the second conveyance path being configured to guide the sheet that is conveyed in the second conveyance direction by the second conveyance unit, a drive unit configured to drive the first conveyance unit and the second conveyance unit, and a control unit configured to control the drive unit. In a case of conveying a preceding sheet from the second conveyance unit to the second conveyance path and conveying a succeeding sheet to the first conveyance path, the control unit is configured to control the drive unit such that a leading edge of the succeeding sheet reaches the first connection portion in a state in which a trailing edge of the preceding sheet is positioned between the first connection portion and the second conveyance unit.

Features of the present disclosure will become apparent from the following description of embodiments with reference to the attached drawings. The following description of embodiments is described by way of example.

### BRIEF DESCRIPTION OF THE DRAWINGS

FIG. 1 is a schematic cross-sectional view illustrating an image forming apparatus according to a first embodiment.

FIG. 2 is a diagram illustrating each conveyance path in the image forming apparatus according to the first embodiment.

FIG. 3 is a diagram illustrating a print sequence in alternate sheet feeding in relation to the number of sheets fed and print sides.

FIG. 4A is a diagram illustrating a position of the sheet during the alternate sheet feeding when printing a first side of a first sheet fed.

FIG. 4B is a diagram illustrating the position of the sheet during the alternate sheet feeding when printing the first side of a second sheet fed.

FIG. 5A is a diagram illustrating the positions of the sheets during the alternate sheet feeding when printing a second side of the first sheet fed and the first side of a third sheet fed.

FIG. 5B is a diagram illustrating the positions of the sheets during the alternate sheet feeding when printing the second side of the second sheet fed and the first side of a fourth sheet fed.

FIG. 6 is an enlarged cross-section view illustrating an area adjacent to a first connection portion connecting a fixing reverse conveyance path and a reverse duplex conveyance path.

FIG. 7 is a diagram illustrating the position of the sheet in a case where a leading edge of a succeeding sheet reaches a margin on a trailing edge side of a preceding sheet.

FIG. 8A is an enlarged cross-sectional view illustrating the reverse duplex conveyance path.

FIG. 8B is an enlarged cross-sectional view illustrating a case where the leading edge of the succeeding sheet has reached the margin on the trailing edge side of the preceding sheet which is positioned in the reverse duplex conveyance path.

FIG. 8C is an enlarged cross-sectional view illustrating a shape of a guide surface of a guide member that forms the reverse duplex conveyance path.

FIG. 9 is an enlarged cross-section view illustrating an area adjacent to the first connection portion between the fixing reverse conveyance path and the reverse duplex conveyance path in an image forming apparatus according to a second embodiment.

### DESCRIPTION OF THE EMBODIMENTS

### First Embodiment

Hereinafter, a first embodiment will be described using diagrams. Configuration of Image Forming Apparatus

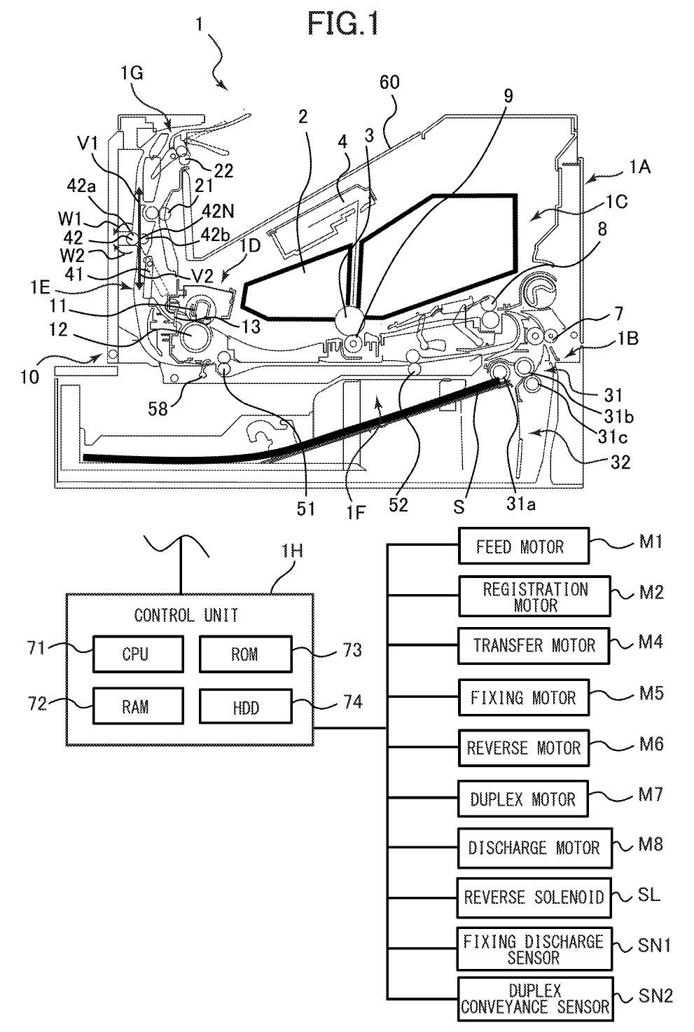

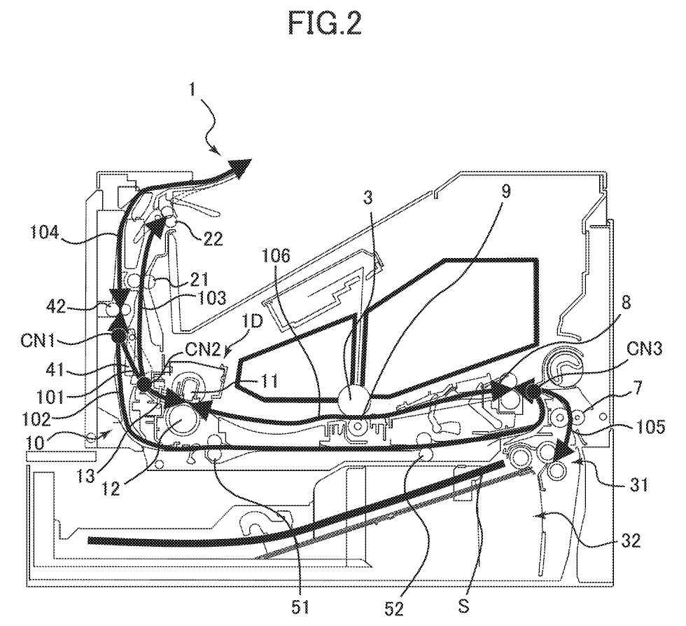

First, using FIG. 1, a configuration of an image forming apparatus according to the first embodiment will be described. FIG. 1 is a schematic cross-sectional view illustrating the image forming apparatus according to the first embodiment. Here, as an example of an image forming apparatus according to this embodiment, a laser printer of an electrophotographic system with duplex printing (duplex image formation) functionality will be described. However, unless otherwise specifically described, the dimensions, materials, shapes, relative arrangements, and the like of the constituent components described in this embodiment are not limited thereto. In addition, in particular, the image forming apparatus according to this embodiment is not limited to laser printers; it may also be any other type of image forming apparatuses such as copiers or facsimiles. To be noted, the schematic cross-sectional view illustrated in FIG. 1 is a cross-sectional view taken in a width direction perpendicularly intersecting a conveyance direction of a sheet. In addition, similarly, the diagrams illustrated in FIGS. 2 and 4 to 9, described in detail below, are views taken in the width direction.

As illustrated in FIG. 1, the image forming apparatus 1 according to the first embodiment includes an apparatus body 1A. The image forming apparatus 1 broadly includes a feeding conveyance portion 1B, an image forming unit 1C, a fixing unit 1D, a sheet reverse portion 1E, a re-conveyance portion 1F, a sheet discharge portion 1G, and a control unit 1H within the apparatus body 1A. To be noted, in this embodiment, among these, a sheet conveyance apparatus 10 that conveys the sheet on which an image has been formed by the image forming unit 1C is constituted by the fixing unit 1D, the sheet reverse portion 1E, the re-conveyance portion 1F, and the sheet discharge portion 1G.

The feeding conveyance portion 1B includes a sheet feed cassette 32 detachably disposed within the apparatus body 1A and serving as a sheet stacking portion for stacking and supporting a plurality of sheets S prior to image formation. In addition, the feeding conveyance portion 1B includes a sheet feed unit 31 that feeds the sheets supported in the sheet feed cassette 32 by separating the sheets into one sheet at a time. Further, the feeding conveyance portion 1B includes a registration roller pair 8, serving as a skew correction unit whose rotational state is controlled by a registration motor M2.

The sheet feed unit 31 includes a pickup roller 31a, a feed roller 31b, and a retard roller 31c, which are driven by a feed motor M1. The pickup roller 31a picks up an uppermost sheet among the plurality of sheets supported in the sheet feed cassette 32. The feed roller 31b and the retard roller 31c come into contact with each other, and form a separation nip portion. While the feed roller 31b conveys the sheet S picked up by the pickup roller 31a, the retard roller 31c exerts a force in the opposite direction. Thereby, even in a case where the plurality of sheet S picked up by the pickup roller 31a are double fed, the sheets are separated into one sheet at a time, and each sheet is fed toward the registration roller pair 8 via a conveyance roller pair 7. To be noted, while, in this embodiment, the retard roller 31c is driven by the same feed motor M1 as the pickup roller 31a and the feed roller 31b via a reverse gear or the like, not shown, the retard roller 31c may be driven by a motor which is different from the feed motor M1.

A leading edge of the sheet S conveyed by the sheet feed unit 31 (or the re-conveyance portion 1F described in detail below) is abutted against the registration roller pair 8 with rotation stopped by the rotation control of the registration motor M2. Thereby, the leading edge of the sheet S is aligned with a nip portion of the registration roller pair 8. Thereafter, the rotation of the registration roller pair 8 is started by the registration motor M2, and the sheet S is conveyed toward the image forming unit 1C with the skew of the sheet S corrected.

The image forming unit 1C includes a process cartridge 2, which is detachably mounted with respect to the apparatus body 1A, a scanner unit 4, a transfer roller 9, and the like. The process cartridge 2 includes process means such as a photosensitive drum 3, a developing unit, not shown, and a charge roller, not shown. The scanner unit 4 is disposed vertically above the process cartridge 2, and performs exposure with respect to the photosensitive drum 3 based on an image signal. The photosensitive drum 3 is rotated in conjunction with the transfer roller 9 by a transfer motor M3, and, after being charged to a predetermined potential of negative polarity by the charge roller, not shown, an electrostatic latent image is formed on the photosensitive drum 3 by the scanner unit 4. This electrostatic latent image is reversely developed as negatively charged toner is applied by the developing unit, not shown, within the process cartridge 2, and, thereby, a toner image is formed on a surface of the photosensitive drum 3. Then, a bias application means, not shown, applies a bias of positive polarity to the transfer roller 9, which is rotatably driven by the transfer motor M3. Thereby, the toner image is transferred as an unfixed toner image onto a surface of the sheet S on a side of the photosensitive drum 3, when the sheet passes through a nip portion between the photosensitive drum 3 and the transfer roller 9.

In this embodiment, the fixing unit 1D serves as a first conveyance unit that conveys the sheet. The fixing unit 1D is heated by a heater, serving as a heating means, not shown, and includes a heating roller 11, serving as a fixing roller rotatably driven by a fixing motor M4, and a pressurizing roller 12, serving as a pressurizing member, which comes into pressure contact with the heating roller 11 and is thereby rotated. That is, the sheet S onto which the toner image has been transferred in the image forming unit 1C as described above is conveyed to the fixing unit 1D disposed downstream of the image forming unit 1C in the conveyance direction. The sheet S conveyed to the fixing unit 1D is nipped and conveyed by a nip portion formed between the heating roller 11 and the pressurizing roller 12, and the toner image is fixed on the surface of the sheet S by the application of heat and pressure. To be noted, a fixing discharge sensor flag 13 is disposed downstream of the fixing unit 1D in the conveyance direction. The fixing discharge sensor flag 13 is actuated when a trailing edge of the sheet S passes through, and the actuation of the fixing discharge flag 13 is detected by a fixing discharge sensor SN1.

The sheet reverse portion 1E includes a duplex inversion flapper 41, serving as a switching member whose position is switched by an inversion solenoid SL, and a reverse roller pair 42, serving as a second conveyance unit to reverse the conveyance direction of the sheet S. The duplex inversion flapper 41 is disposed downstream of the fixing unit 1D in the conveyance direction of the sheet by the fixing unit 1D, and switches a conveyance path. That is, the duplex inversion flapper 41 can be switched (switchable) between a first position (dashed-line position in FIG. 1) and a second position (solid-line position in FIG. 1). At the first position, the duplex inversion flapper 41 guides the sheet conveyed from the fixing unit 1D to the reverse roller pair 42, and, at the second position, guides the sheet conveyed from the fixing unit 1D to an intermediate conveyance roller pair 21, serving as a third conveyance unit, of the sheet discharge portion 1G, described below.

In a case of simplex image formation (simplex printing), in which the image is formed only on a first side (one side) of the sheet S, the duplex inversion flapper 41 is switched to the second position under the control of the control unit 1H. Thereby, the sheet S conveyed from the fixing unit 1D is conveyed to the sheet discharge portion 1G, described below. On the other hand, in a case of duplex image formation (duplex printing), in which the image is formed on the first and second sides (both sides) of the sheet S, after the image has been formed on the first side of the sheet S, the duplex inversion flapper 41 is switched to the first position under the control of the control unit 1H. Thereby, the sheet S conveyed from the fixing unit 1D is conveyed to the reverse roller pair 42.

The reverse roller pair 42 includes a drive roller 42a, serving as a first roller rotatably driven by a reverse motor M5, which functions as a drive unit, and a driven roller 42b, serving as a second roller driven by the drive roller 42a. That is, the sheet S can be nipped to be conveyed by the drive and driven rollers 42a and 42b. The drive roller 42a is rotatably driven by the reverse motor M5, which is controlled by the control unit 1H, and a rotational direction of the drive roller 42a can be switched between a first rotational direction W1 and a second rotational direction W2 opposite to the first rotational direction W1. That is, in a case where the drive roller 42a is rotatably driven in the first rotational direction W1 with the drive and driven rollers 42a and 42b being in contact with the sheet S, the reverse roller pair 42 conveys the sheet S in a first conveyance direction V1. In addition, in a case where the drive roller 42a is rotatably driven in the second rotational direction W2 opposite to the first rotational direction W1 with the drive and driven rollers 42a and 42b being in contact with the sheet S, the reverse roller pair 42 conveys the sheet S in a second conveyance direction V2 opposite to the first conveyance direction V1. To be noted, these first and second conveyance directions V1 and V2 correspond to a tangential direction at a nip portion 42N formed by the drive and driven rollers 42a and 42b, that is, directions in which the sheet S is conveyed by the nip portion 42N of the reverse roller pair 42.

In the case of the duplex image formation (duplex printing), the drive roller 42a is rotatably driven in the first rotational direction W1 by the reverse motor M5, and the reverse roller pair 42, which is configured as described above, conveys the sheet S in the first conveyance direction V1. Thereafter, the drive roller 42a is rotatably driven in the second rotational direction W2 opposite to the first rotational direction W1, and, thereby, the reverse roller pair 42 conveys the sheet S with the conveyance direction of the sheet S reversed (switched) to the second conveyance direction V2. Thus, the sheet S is conveyed to the re-conveyance portion 1F with the leading and trailing edges of the sheet S reversed.

The re-conveyance portion 1F includes a duplex conveyance roller pair 51, serving as a fourth conveyance unit driven by a duplex motor M6, and a re-feeding roller pair 52. The re-conveyance portion 1F re-conveys the sheet S, which has been conveyed from the sheet reverse portion 1E by the reverse roller pair 42, to the registration roller pair 8 of the feeding conveyance portion 1B described above. That is, the leading and trailing edges of the sheet S have been reversed by the reverse roller pair 42 of the sheet reverse portion 1E, and this reversed sheet S is re-conveyed to the registration roller pair 8. Thereby, the image forming unit 1C forms the toner image on the second side opposite to the first side of the sheet S through the image forming process described above, and the fixing unit 1D fixes the toner image on the second side of the sheet S. To be noted, a duplex conveyance sensor flag 58, which is actuated when the trailing edge of the sheet S passes through, is disposed upstream of the duplex conveyance roller pair 51 in the conveyance direction. The actuation of the duplex conveyance sensor flag 58 is detected by a duplex conveyance sensor SN2.

The sheet discharge portion 1G includes the intermediate conveyance roller pair 21 and a sheet discharge roller pair 22, which are driven by a discharge motor M7, and a sheet discharge tray 60 which is formed on an upper surface of the apparatus body 1A and stacks discharged sheets. The sheet is discharged to the sheet discharge tray 60 from a discharge port (sheet discharge port) of the apparatus body 1A by the sheet discharge roller pair 22. In the case of the simplex printing, after the image has been formed on a front surface (first side) of the sheet S, the duplex inversion flapper 41 is switched to the second position, and the sheet S is conveyed from the fixing unit 1D to the sheet discharge portion 1G. Alternatively, in the case of the duplex printing, after the image has been formed on a back surface (second side) of the sheet S, the duplex inversion flapper 41 is switched to the second position, and the sheet S is conveyed from the fixing unit 1D to the sheet discharge portion 1G. Then, the sheet discharge portion 1G discharges the sheet S, which has been conveyed, by conveying the sheet to the sheet discharge tray 60 using the intermediate conveyance roller pair 21 and the sheet discharge roller pair 22, and stacks the duplex printed sheet S onto the sheet discharge tray 60. Thereby, the simplex or duplex printing is completed in the image forming apparatus 1.

The control unit 1H is a controller that performs various control operations in the image forming apparatus 1, and includes a central processing unit (CPU) 71, serving as an example of a processor, and, as memory units, a random access memory (RAM) 72, a read only memory (ROM) 73, and a hard disk drive (HDD) 74. To be noted, the CPU 71, the RAM 72, the ROM 73, and the HDD 74 are connected via a bus so as to be capable of communicating information with each other, and are communicatively connected to controllers of respective units, an operation unit, and the like, not shown, through interfaces, not shown. Then, the control unit 1H is connected to various drive motors, various solenoids, various sensors, and the like via interfaces, not shown. In particular, the control unit 1H is electrically connected to the feed motor M1, the registration motor M2, the transfer motor M3, the fixing motor M4, the reverse motor M5, the duplex motor M6, the discharge motor M7, the reverse solenoid SL, the fixing discharge sensor SN1, the duplex conveyance sensor SN2, and the like. The control unit 1H transmits signals to these components to freely achieve control. In particular, in this embodiment, the control unit 1H is capable of freely controlling the conveyance direction and a conveyance position of the sheet S that is reversed by the reverse roller pair 42. Details of the control regarding the conveyance of the sheet S by this control unit 1H will be collectively described below, alongside the description of a conveyance operation of the sheet S.

### Definition of Conveyance Paths of Image Forming Apparatus

Next, using FIG. 2, definitions of each conveyance path in the image forming apparatus 1 according to the first embodiment will be described. FIG. 2 is a diagram illustrating each conveyance path in the image forming apparatus 1 according to the first embodiment. The image forming apparatus 1 according to the first embodiment includes a plurality of conveyance paths which continuously communicate (connected) from the sheet feed cassette 32 to the sheet discharge tray 60 and are partitioned by conveyance guide members, flappers, and the like so as to guide the sheet along the paths. In addition, the image forming apparatus 1 according to this embodiment includes a plurality of connection portions at which two among the plurality of conveyance paths are connected. In order to describe positions of the sheet S in such conveyance paths, descriptions will be provided utilizing the following conveyance paths and connection portions, segmented for convenience.

In particular, in the image forming apparatus 1, the following definitions apply. Feed registration conveyance path 105: A conveyance path from the sheet feed unit 31 to the registration roller pair 8. Registration fixing conveyance path 106: A conveyance path from the registration roller pair 8 to the fixing unit 1D (to the nip portion between the heating roller 11 and the pressurizing roller 12). Fixing reverse conveyance path 101: A conveyance path from the fixing unit 1D to the reverse roller pair 42 (to the nip portion 42N between the drive and driven rollers 42a and 42b). Reverse duplex conveyance path 102: A conveyance path from the reverse roller pair 42 to the registration roller pair 8 via the duplex conveyance roller pair 51 and the re-conveyance roller pair 52. Fixing discharge conveyance path 103: A conveyance path from the fixing unit 1D to the sheet discharge roller pair 22 via the intermediate conveyance roller pair 21. Reverse downstream conveyance path 104: A conveyance path disposed downstream from the reverse roller pair 42 in the conveyance direction in a case where the sheet S is conveyed from the fixing unit 1D to the reverse roller pair 42. First connection portion CN1: A connection portion at which the reverse duplex conveyance path 102 is connected to the fixing reverse conveyance path 101. Second connection portion CN2: A connection portion at which the fixing discharge conveyance path 103 is connected to the fixing reverse conveyance path 101. Third connection portion CN3: A connection portion at which the reverse duplex conveyance path 102 is connected to the feed registration conveyance path 105.

To be noted, in this embodiment, the fixing reverse conveyance path 101 constitutes a first conveyance path that guides the sheet conveyed from the fixing unit 1D to the reverse roller pair 42. In addition, the reverse duplex conveyance path 102 which is connected to the first conveyance path (fixing reverse conveyance path 101) at the first connection portion CN1 and is connected to the feed registration conveyance path 105 at the third connection portion CN3 constitutes a second conveyance path that guides the sheet S in the second conveyance direction V2. Here, the first connection portion CN1 is positioned between the fixing unit 1D and the reverse roller pair 42 in the conveyance direction. To be noted, strictly speaking, the second conveyance path corresponds to the reverse duplex conveyance path 102 from the first connection portion CN1 to the third connection portion CN3. The third connection portion CN3 is positioned between the sheet feed unit 31 and the image forming unit 1C in the conveyance direction. In addition, a portion of the fixing discharge conveyance path 103, which is connected to the first conveyance path (fixing reverse conveyance path 101) at the second connection section CN2, constitutes a third conveyance path that branches from the first conveyance path (fixing reverse conveyance path 101) and guides the sheet S toward the sheet discharge tray 60. Here, the second connection portion CN2 is positioned between the fixing unit 1D and the first connection portion CN1 in the conveyance direction. Then, the feed registration conveyance path 105 and the registration fixing conveyance path 106 constitute a fourth conveyance path that guides the sheet S from the sheet feed unit 31 to the fixing unit 1D through the image forming unit 1C and merges with the second conveyance path at the third connection portion CN3. As illustrated in FIG. 2, the leading edge of the sheet S conveyed to the reverse downstream conveyance path 104 by the reverse roller pair 42 may project outside the apparatus body 1A through an opening of the apparatus body 1A. At this time, the opening of the apparatus body 1A differs from the discharge port of the apparatus body 1A.

### Print Sequence during Alternate Feeding

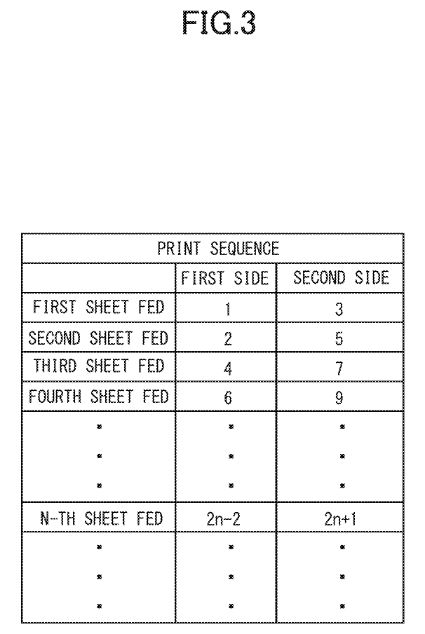

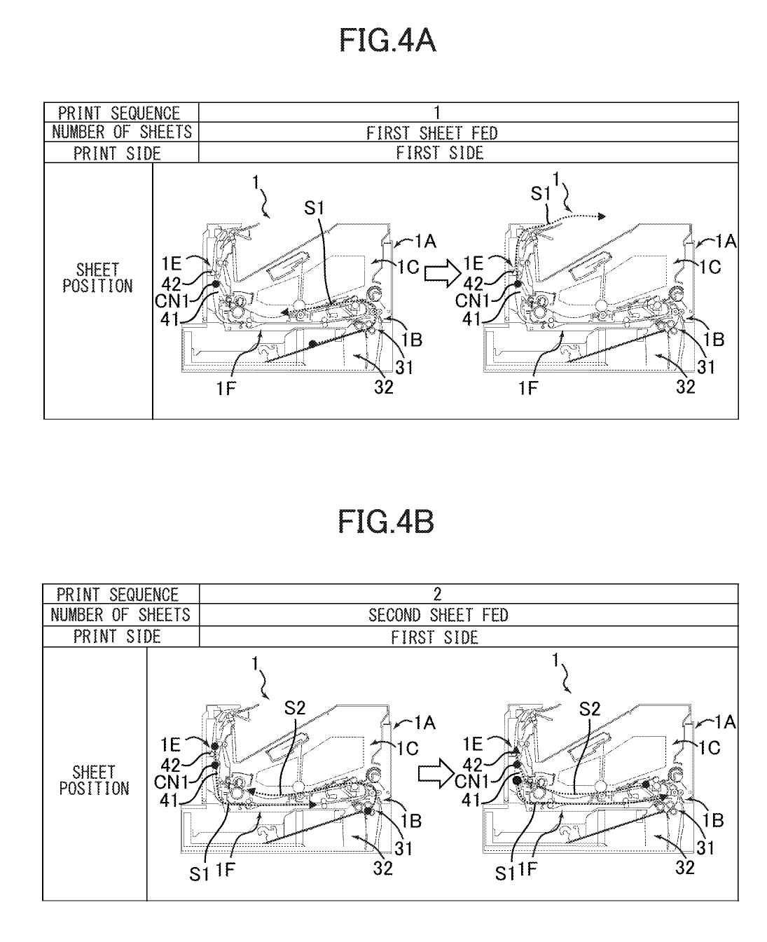

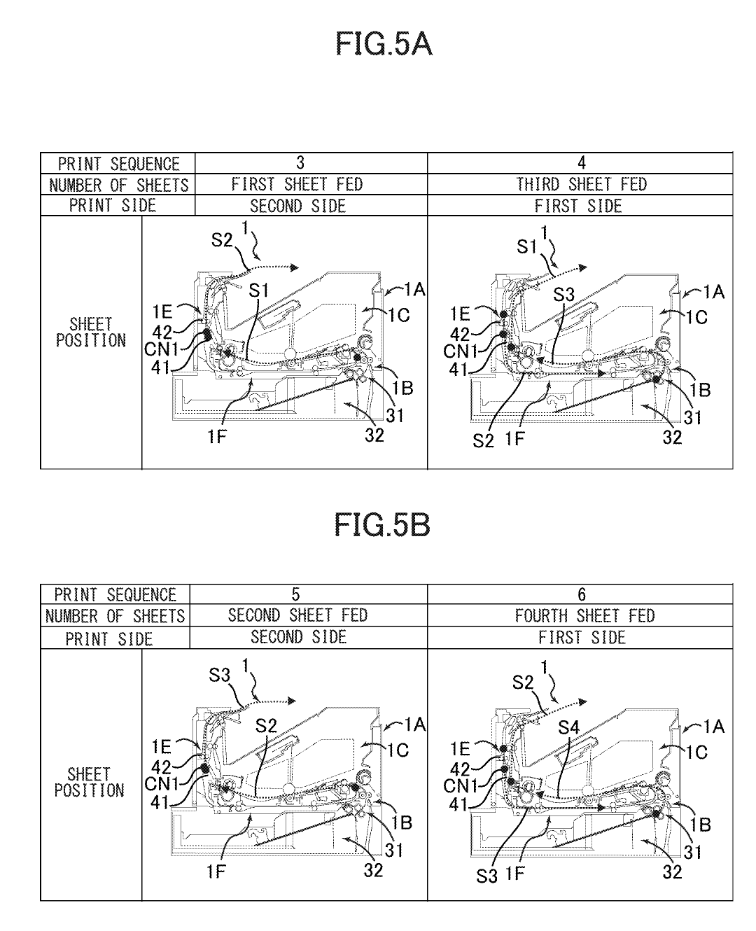

Next, using FIGS. 3 to 5, a print sequence in relation to the number of sheets fed and print sides during alternate sheet feeding in the image forming apparatus 1 according to this embodiment will be described. FIG. 3 is a diagram illustrating the print sequence in relation to the number of sheets fed and the print sides during the alternate sheet feeding. FIG. 4A is a diagram illustrating the position of the sheet in a case of printing a first side of a first sheet fed during the alternate sheet feeding. FIG. 4B is a diagram illustrating the position of the sheet in a case of printing the first side of a second sheet fed during the alternate sheet feeding. FIG. 5A is a diagram illustrating the positions of the sheets in a case of printing a second side of the first sheet fed and the first side of a third sheet fed during the alternate sheet feeding. FIG. 5B is a diagram illustrating positions of the sheet in a case of printing the second side of the second sheet fed and the first side of a fourth sheet fed during the alternate sheet feeding. To be noted, in the following description, to distinguish between the sheets S, a sequential feed count number of sheets continuously fed by the feeding conveyance portion 1B in a series of print jobs will be appended to reference characters for explanation. In addition, the symbol “n” indicates that the feed count is the “n-th sheet”.

### State of Printing First Side of First Sheet Fed

As illustrated in FIGS. 3 and 4A, for example, when a print job for the duplex printing of a plurality of sheets is started by the control unit 1H, the control unit 1H feeds the first sheet S1 from the sheet feed cassette 32 toward the image forming unit 1C via the registration roller pair 8. This first sheet S1 is conveyed through the feed registration conveyance path 105 and the registration fixing conveyance path 106 (refer to FIG. 2), so that the image is formed on the first side by the image forming unit 1C and fixed by the fixing unit 1D. Thereafter, this first sheet S1 is conveyed through the duplex inversion flapper 41, which has been switched to the first position, and is conveyed from the fixing reverse conveyance path 101 to the reverse downstream conveyance path 104 by the fixing unit 1D and the reverse roller pair 42, which are rotatably driven (refer to FIG. 2). Then, in accordance with timing at which a trailing edge of the sheet S1 is detected by the fixing discharge sensor SN1 (fixing discharge sensor flag 13), the control unit 1H stops the conveyance of the sheet S1 at a position at which the trailing edge of the first sheet S1 is positioned upstream of the reverse roller pair 42 in the conveyance direction.

### State of Printing First Side of Second Sheet Fed

Next, as illustrated in FIGS. 3 and 4B, the control unit 1H switches the duplex inversion flapper 41 to the second position, and rotatably drives the reverse roller pair 42 in a reverse direction, so that the first sheet S1 described above is conveyed to the reverse duplex conveyance path 102 (refer to FIG. 2). Next, the control unit 1H feeds the second sheet S2 from the sheet feed cassette 32 toward the image forming unit 1C via the registration roller pair 8. At this time, the control unit 1H controls such that a leading edge of the first sheet S1 (preceding sheet) reaches the third connection portion CN3 after a trailing edge of the second sheet S2 (succeeding sheet) has cleared the third connection portion CN3. Then, similarly, this second sheet S2 is also conveyed through the feed registration conveyance path 105 and the registration fixing conveyance path 106 (refer to FIG. 2), so that the image is formed on the first side by the image forming unit 1C and fixed by the fixing unit 1D. Thereafter, this second sheet S2 is also conveyed through the duplex inversion flapper 41, which has been switched to the first position, and is conveyed to the fixing reverse conveyance path 101 by the fixing unit 1D and the reverse roller pair 42, which are rotatably driven (refer to FIG. 2).

### State of Printing Second Side of First Sheet Fed

Next, as illustrated in FIGS. 3 and 5A, the control unit 1H conveys the second sheet S2 from the fixing reverse conveyance path 101 to the reverse downstream conveyance path 104 by the reverse roller pair 42, which is rotatably driven (refer to FIG. 2). Next, the control unit 1H feeds the first sheet S1, which is positioned in the reverse duplex conveyance path 102, toward the image forming unit 1C. The conveyance direction of this first sheet S1 has been reversed by the reverse roller pair 42, and the front and back sides are inverted when conveyed from the reverse duplex conveyance path 102 to the registration roller pair 8. Then, the first sheet S1 is conveyed through the feed registration conveyance path 105 and the registration fixing conveyance path 106 (refer to FIG. 2), so that the image is formed on the second side by the image forming unit 1C and fixed by the fixing unit 1D.

### State of Printing First Side of Third Sheet Fed

Thereafter, as illustrated in FIGS. 3 and 5A, the control unit 1H conveys the first sheet S1 from the fixing discharge conveyance path 103 toward the sheet discharge tray 60 via the duplex inversion flapper 41, which has been switched to the second position (refer to FIG. 2). In addition, the control unit 1H reverses the rotational direction of the reverse roller pair 42, and rotatably drives the reverse roller pair 42, so that the second sheet S2 described above is conveyed to the reverse duplex conveyance path 102 (refer to FIG. 2). Then, the control unit 1H feeds the third sheet S3 from the sheet feed cassette 32 toward the image forming unit 1C via the registration roller pair 8. Then, similarly, this third sheet S3 is also conveyed through the feed registration conveyance path 105 and the registration fixing conveyance path 106 (refer to FIG. 2), so that the image is formed on the first side by the image forming unit 1C and fixed by the fixing unit 1D. Thereafter, this third sheet S3 is also conveyed through the duplex inversion flapper 41, which has been switched to the first position, and is conveyed to the fixing reverse conveyance path 101 by the fixing unit 1D and the reverse roller pair 42, which are rotatably driven (refer to FIG. 2).

### State of Printing Second Side of Second Sheet Fed

Next, as illustrated in FIGS. 3 and 5B, the control unit 1H conveys the third sheet S3 from the fixing reverse conveyance path 101 to the reverse downstream conveyance path 104 by the reverse roller pair 42, which is rotatably driven (refer to FIG. 2). Next, the control unit 1H feeds the second sheet S2, which is positioned in the reverse duplex conveyance path 102, toward the image forming unit 1C. The conveyance direction of this second sheet S2 has been reversed by the reverse roller pair 42, and the front and back sides are inverted when conveyed from the reverse duplex conveyance path 102 to the registration roller pair 8. Then, the second sheet S2 is conveyed through the feed registration conveyance path 105 and the registration fixing conveyance path 106 (refer to FIG. 2), so that the image is formed on the second side by the image forming unit 1C and fixed by the fixing unit 1D.

### State of Printing First Side of Fourth Sheet Fed

Thereafter, as illustrated in FIGS. 3 and 5B, the control unit 1H conveys the second sheet S2 from the fixing discharge conveyance path 103 toward the sheet discharge tray 60 via the duplex inversion flapper 41, which has been switched to the second position (refer to FIG. 2). In addition, the control unit 1H reverses the rotational direction of the reverse roller pair 42, and rotatably drives the reverse roller pair 42, so that the third sheet S3 described above is conveyed to the reverse duplex conveyance path 102 (refer to FIG. 2). Then, the control unit 1H feeds the fourth sheet S4 from the sheet feed cassette 32 toward the image forming unit 1C via the registration roller pair 8. Similarly, this fourth sheet S4 is also conveyed through the feed registration conveyance path 105 and the registration fixing conveyance path 106 (refer to FIG. 2), so that the image is formed on the first side by the image forming unit 1C and fixed by the fixing unit 1D. Thereafter, this fourth sheet S4 is also conveyed through the duplex inversion flapper 41, which has been switched to the first position, and is conveyed to the fixing reverse conveyance path 101 by the fixing unit 1D and the reverse roller pair 42, which are rotatably driven (refer to FIG. 2).

### State of Subsequent Duplex Printing via Alternate Sheet Feeding

After the state of printing the first side of the fourth sheet fed is completed as described above, the conveyance operations of the sheet S illustrated in FIGS. 3, 5A, and 5B are repeated, and the images are formed on the first and second sides of each sheet S. That is, a sequence for printing the first side of the n-th sheet fed becomes “2n - 2 (1<n), 1 if n=1”, while a sequence for printing the second side of the n-th sheet fed becomes “2n + 1 (1<=n)”. Characteristic of Conveyance Control in Alternate Sheet Feeding according to This Embodiment

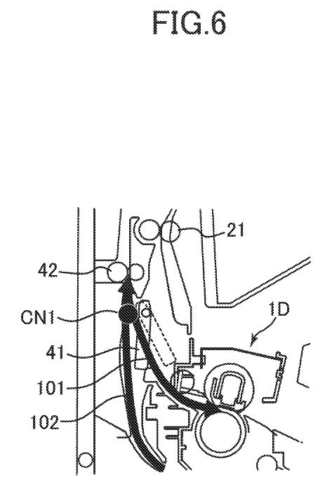

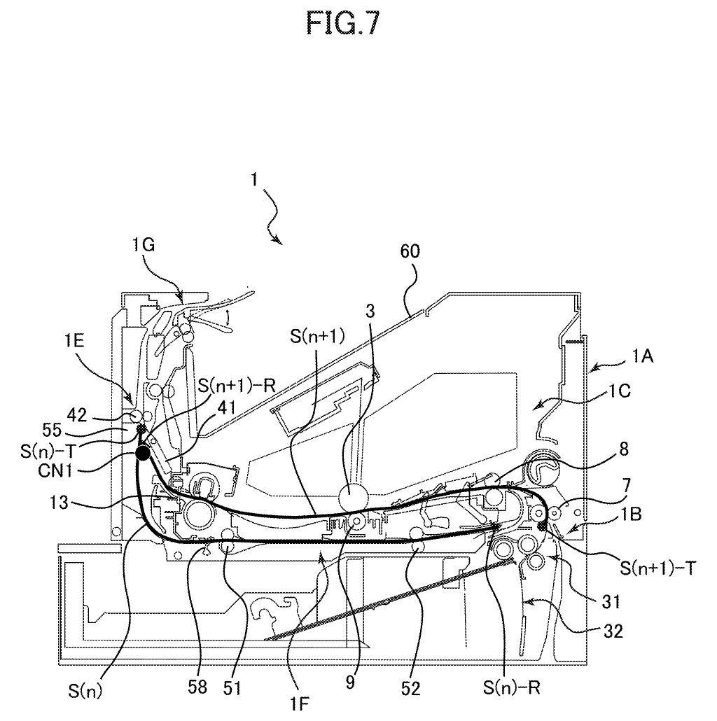

Next, using FIGS. 6 and 7, an overlap between a preceding sheet (hereinafter, referred to as “preceding sheet S(n)” and a succeeding sheet (hereinafter, referred to as “succeeding sheet S(n+1)”), which is a characteristic of conveyance control in the alternate sheet feeding according to this embodiment, will be described. FIG. 6 is an enlarged cross-sectional view illustrating an area adjacent to the first connection portion between the fixing reverse conveyance path and the reverse duplex conveyance path. FIG. 7 is a diagram illustrating a sheet position in a case where a leading edge of the succeeding sheet has reached a margin on a side of a trailing edge of the preceding sheet. To be noted, the preceding sheet S(n) and the succeeding sheet S(n+1) illustrated in FIG. 7 are sheets whose dimensions correspond to a maximum allowable length for the alternate sheet feeding in the conveyance direction. The conveyance control described below is executed by the control unit 1H described above, which regulates each motor, serving as a drive unit, to control a conveyance position of the sheet.

As illustrated in FIG. 7, the preceding sheet S(n) enters the reverse duplex conveyance path 102 when the reverse roller pair 42 reverses rotation. Thereafter, a leading edge S(n)-R of the preceding sheet S(n) is detected by the duplex conveyance sensor SN2 (duplex conveyance sensor flag 58). In accordance with the timing of the detection of the leading edge S(n)-R by this duplex conveyance sensor SN2, the rotation of the duplex conveyance roller pair 51 and the re-conveyance roller pair 52 is stopped so as to position the leading edge S(n)-R downstream of the re-conveyance roller pair 52 in the conveyance direction, and the conveyance of the preceding sheet S(n) is stopped.

Then, in this state, the preceding sheet S(n) is stopped in a state in which the trailing edge S(n)-T of the preceding sheet S(n) is positioned between the first connection portion CN1 and the reverse roller pair 42 in the second conveyance direction V2 (refer to FIG. 1). Thereafter, the succeeding sheet S(n+1) is conveyed along the fixing reverse conveyance path 101, and, as illustrated in FIG. 6, its leading edge S(n+1)-R comes into contact with a trailing edge portion of the preceding sheet S(n) at the first connection portion CN1. Then, the succeeding sheet S(n+1) is conveyed toward the reverse roller pair 42 by the fixing unit 1D with its leading edge S(n+1)-R overlapping the preceding sheet S(n). Thereafter, when the leading edge S(n+1)-R of the succeeding sheet S(n+1) reaches the reverse roller pair 42, the succeeding sheet S(n+1) is brought into contact with and is nipped by the drive and driven rollers 42a and 42b; thereby, the succeeding sheet S(n+1) is conveyed in the first conveyance direction V1. To be noted, the trailing edge portion of the preceding sheet S(n) with which the leading edge S(n+1)-R of the succeeding sheet S(n+1) comes into contact is located within a non-printable area outside an image forming area in which the image is printed by the image forming unit 1C; that is, it is within the margin. In other words, the control unit 1H controls such that, when the leading edge S(n+1)-R of the succeeding sheet S(n+1) reaches the first connection portion CN1, the image formed on the first side of the preceding sheet S(n) has passed through the first connection portion CN1 in the second conveyance direction V2.

As described above, in the conveyance control in the alternate sheet feeding according to this embodiment, a region in which the preceding sheet S(n) and the succeeding sheet S(n+1) overlap is provided between the first connection portion CN1 and the reverse roller pair 42. Thereby, it is possible to reduce the length of the reverse duplex conveyance path 102; thus, it is possible to miniaturize the image forming apparatus 1 (sheet conveyance apparatus 10), and it is also possible to enhance productivity for the duplex printing.

In addition, the succeeding sheet S(n+1) conveyed from the fixing reverse conveyance path 101 is conveyed toward the reverse downstream conveyance path 104 in the first conveyance direction V1 by the reverse roller pair 42, and, thereafter, is conveyed toward the reverse duplex conveyance path 102 by being reversed in the second conveyance direction V2. As described above, when the succeeding sheet S(n+1) is conveyed, the drive and driven rollers 42a and 42b of the reverse roller pair 42 always come into contact with (nip) and convey the succeeding sheet S(n+1). Therefore, a distance between a position at which the reverse roller pair 42 nips the succeeding sheet S(n+1) and the leading edge S(n+1)-R of the succeeding sheet S(n+1) becomes shorter than, for example, a case where the sheet is conveyed by the fixing unit 1D without being nipped by the reverse roller pair 42. Therefore, it is possible to stabilize the conveyance of the succeeding sheet S(n+1).

In addition, the trailing edge portion of the preceding sheet S(n) includes the non-printable area (margin), and a position at which the succeeding sheet S(n+1) comes into contact with the preceding sheet S(n) at the first connection portion CN1 is set to fall within the non-printable area. Therefore, the succeeding sheet S(n+1) does not come into contact with the printed image on the first side of the preceding sheet S(n), and, thereby, it is possible to prevent image turbulence.

In addition, for example, in a case where the preceding sheet S(n) and the succeeding sheet S(n+1) are conveyed in an overlapped manner into the reverse roller pair 42, it is necessary to dispose a separation mechanism that can separate the drive roller 42a and the driven roller 42b from each other, or to employ a D-shaped roller configuration in the widthwise view. In such cases, there is a risk that the increased cost of the separation mechanism or roller components themselves may result in higher manufacturing costs for the image forming apparatus 1. However, in this embodiment, the region in which the preceding sheet S(n) and the succeeding sheet S(n+1) overlap is disposed between the first connection portion CN1 and the reverse roller pair 42; therefore, the preceding sheet S(n) and the succeeding sheet S(n+1) do not overlap at the reverse roller pair 42. Thereby, it is possible to prevent an increase in the manufacturing costs for the image forming apparatus 1.

### Reverse Duplex Conveyance Path 102

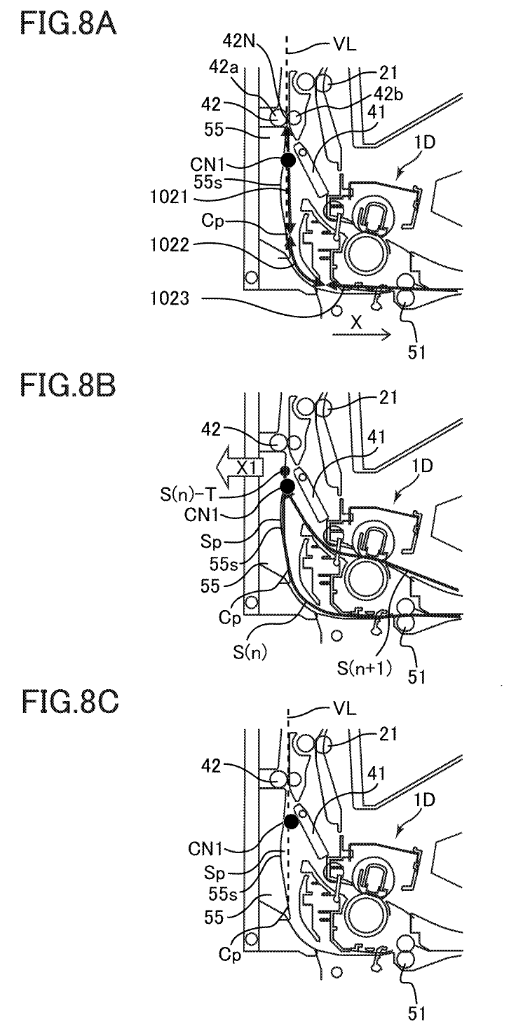

Next, using FIGS. 8A to 8C, a configuration of the reverse duplex conveyance path 102 and a configuration of a guide surface 55s of a conveyance guide 55 will be described. FIG. 8A is an enlarged cross-sectional view illustrating the reverse duplex conveyance path. FIG. 8B is an enlarged cross-sectional view illustrating a case where the leading edge of the succeeding sheet reaches the margin on the side of the trailing edge of the preceding sheet positioned in the reverse duplex conveyance path. FIG. 8C is an enlarged cross-sectional view illustrating the configuration of the guide surface of the guide member forming the reverse duplex conveyance path.

As illustrated in FIG. 8A, the reverse duplex conveyance path 102 broadly includes a first linear portion 1021, a curved portion 1022, and a second linear portion 1023. The first linear portion 1021 is formed in a linear configuration extending from the reverse roller pair 42 toward the second conveyance direction V2 (refer to FIG. 1). In particular, in the widthwise view, the first linear portion 1021 is a portion that guides the sheet S by extending linearly from the first connection portion CN1 in a direction of a virtual line VL, which connects the nip portion 42N of the drive and driven rollers 42a and 42b and the first connection portion CN1.

The curved portion 1022 is positioned downstream of the first linear portion 1021 and upstream of the second linear portion 1023 in the conveyance direction, and is configured with a curvature that curves to connect the two linear portions. That is, the curved portion 1022 is a portion that communicates with the first linear portion 1021, and, in the widthwise view, extends in a curved configuration toward an intersecting direction X (lateral direction in FIG. 8A), intersecting the virtual line VL so as to guide the sheet S. Then, the second linear portion 1023 communicates with the curved portion 1022, and is formed to extend linearly in the intersecting direction X from the curved portion 1022; in other words, the second linear portion 1023 is a portion that guides the sheet S in a straight path along the intersecting direction X.

The first linear portion 1021 is formed between the conveyance guide 55 and the duplex inversion flapper 41. The conveyance guide 55 includes a guide surface 55s that guides the sheet S. Then, the guide surface 55s is formed with a concave configuration in the form of an arc, which, in the widthwise view, is recessed with respect to the virtual line VL in a direction (in an arrow X1 direction in FIG. 8B) opposite to the intersecting direction X.

Here, a connection portion between the first linear portion 1021 and the curved portion 1022 is referred to as a connection portion Cp. As illustrated in FIG. 8B, when the succeeding sheet S(n+1) comes into contact with the preceding sheet S(n) at the first connection portion CN1, a portion of the preceding sheet S(n) positioned in the curved portion 1022 is bent in the curved portion 1022. Then, as described above, the guide surface 55s of the conveyance guide 55 is formed in the arcuate configuration. In other words, as illustrated in FIG. 8C, the guide surface 55s between the first connection portion CN1 and the connection portion Cp in the conveyance direction is separated from the virtual line VL, and thereby forms a space Sp between the preceding sheet S(n) and the guide surface 55s.

Here, when the preceding sheet S(n) is bent by the curved portion 1022, there is a possibility that the preceding sheet S(n) may deflect due to its rigidity (stiffness), and, as a result, the trailing edge S(n)-T of the preceding sheet S(n) may lift away from the guide surface 55s. In other words, there is a possibility that the trailing edge S(n)-T of the preceding sheet S(n) may be directed toward the duplex inversion flapper 41 in an area adjacent to the first connection portion CN1.

However, since the guide surface 55s is formed in the arcuate configuration and forms the space Sp separated from the virtual line VL, the trailing edge S(n)-T of the preceding sheet S(n) moves in the arrow X1 direction along the guide surface 55s. Therefore, the trailing edge S(n)-T of the preceding sheet S(n) is conveyed along the conveyance guide 55 in the area adjacent to the connection portion CN1. As a result, when being conveyed from the first connection portion CN1 by the reverse roller pair 42, the succeeding sheet S(n+1) is guided by the preceding sheet S(n) conveyed along the guide surface 55s. In particular, since, at this time, the preceding sheet S(n) is in a stopped state, the succeeding sheet S(n+1) is stably conveyed in substantially the same manner as being directly guided by the guide surface 55s of the conveyance guide 55. To be noted, the configuration of the guide surface 55s of the conveyance guide 55 between the first connection portion CN1 and the connection portion Cp in the conveyance direction may be a planar shape parallel to the virtual line VL, instead of the arcuate configuration.

To be noted, in the first embodiment described above, the succeeding sheet S(n+1) is brought into contact at the first connection portion CN1 in a state in which the conveyance of the preceding sheet S(n) is stopped. However, the succeeding sheet S(n+1) may be brought into contact with the preceding sheet S(n) while maintaining the conveyance of the preceding sheet S(n) without stopping. Thereby, it is possible to reduce a distance between the trailing edge S(n+1)-T of the succeeding sheet S(n+1), which is directed from the fixing reverse conveyance path 101 toward the reverse downstream conveyance path 104, and the leading edge S(n)-R of the preceding sheet S(n), which is directed from the reverse duplex conveyance path 102 to the registration fixing conveyance path 106. In other words, it is possible to reduce a distance between the sheets, and, thereby, it is possible to improve productivity for the duplex printing.

### Second Embodiment

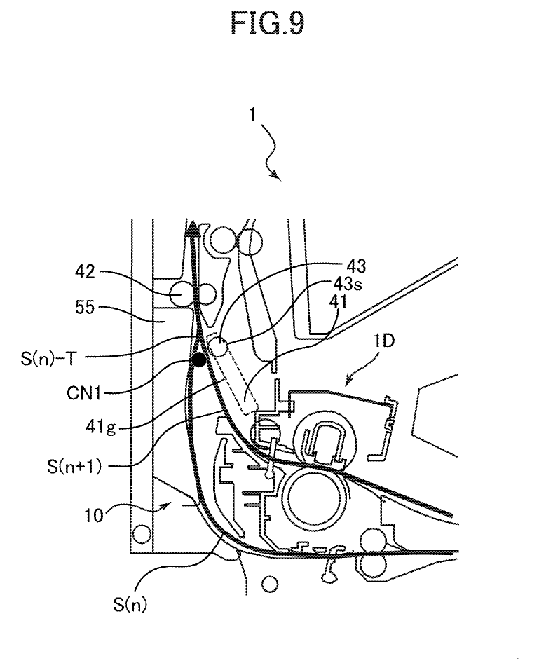

Next, using FIG. 9, a second embodiment will be described in which the first embodiment is partly modified. FIG. 9 is an enlarged cross-sectional view illustrating an area adjacent to the first connection portion between the fixing reverse conveyance path and the reverse duplex conveyance path of an image forming apparatus according to the second embodiment. To be noted, in this embodiment, the same reference characters are used for components identical to those in the first embodiment, and their description will be omitted herein.

In a sheet conveyance apparatus 10 in the image forming apparatus 1 according to this second embodiment, as compared with the first embodiment described above, a duplex reverse roller 43, serving as a driven rotary member that is brought into contact with the sheet S and rotated by the sheet, is disposed with respect to the duplex inversion flapper 41.

In particular, as illustrated in FIG. 9, the duplex reverse roller 43 is positioned adjacent to the first connection portion CN1, and its circumferential surface 43s is projected from a guide surface 41g of the duplex inversion flapper 41. For example, assume that the trailing edge S(n)-T of the preceding sheet S(n) curls, and that the preceding sheet S(n) presses the succeeding sheet S(n+1), which is conveyed into the reverse downstream conveyance path 104, toward a side of the guide surface 41g of the duplex inversion flapper 41. Even in this case, the succeeding sheet S(n+1) is guided by the duplex reverse roller 43 which is rotatably driven, and the guide surface 41g does not come into contact with the succeeding sheet S(n+1). Therefore, when the succeeding sheet S(n+1) comes into contact with the duplex reverse roller 43 which is rotatably driven, sliding resistance at a contact portion with the succeeding sheet S(n+1) is reduced, and, thereby, it is possible to reduce image turbulence on the first side of the succeeding sheet S(n+1).

To be noted, in this second embodiment, the duplex reverse roller 43, serving as the driven rotary member, is disposed with respect to the duplex inversion flapper 41; however, it is not limited to this. For example, the duplex reverse roller 43 may be disposed to be fixedly supported with respect to the apparatus body 1A in an area adjacent to a base of the duplex inversion flapper 41. In other words, it is sufficient that the duplex reverse roller 43 is arranged between the fixing unit 1D and the reverse roller pair 42, and arranged such that the duplex reverse roller 43 rotates while coming into contact with a surface of the sheet, which is guided along the fixing reverse conveyance path 101, on a side opposite to the reverse duplex conveyance path 102.

### Possibilities of Other Embodiments

To be noted, in the first and second embodiments described above, as an example, the image forming apparatus 1 is described to be a compact, so-called desktop-type laser printer; however, it is not limited to this. For example, it may also be an image forming apparatus used for such as multifunction office devices or image forming systems for commercial printing applications. In addition, it is not limited to apparatuses that perform monochrome printing, and may include apparatuses that execute color printing. Further, as the sheet conveyance apparatus, it is not limited to those including image forming units for image formation, and, for example, may be sheet conveyance apparatuses of processing apparatuses such as finishers, or scanner units that read the image.

In addition, in the first and second embodiments described above, the sheet reverse portion 1E inverts the front and back of the sheet for the duplex printing; however, it is not limited to this. For example, the sheet reverse portion 1E may be configured to invert the front and back of the sheet so as to discharge the sheet to the sheet discharge tray with the front surface facing upward, or discharge the sheet to the sheet discharge tray with the front surface facing downward. Further, in the sheet reverse portion 1E, after the sheet has been conveyed upward, the sheet is reversed and conveyed downward; however, these directions may be reversed in the vertical direction, or may even be configured along the horizontal direction; in other words, the conveyance directions may be configured arbitrarily.

The present disclosure can also be realized by a process of providing a program that realizes one or more functions of the above-described embodiments to a system or a device via a network or a storage medium, and having one or more processors in the computer of the system or device read and execute the program. It can also be realized by a circuit (e.g., ASIC) that realizes one or more functions.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a 'non-transitory computer-readable storage medium') to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2025-034652, filed March 5, 2025, which is hereby incorporated by reference herein in its entirety.

What is claimed is:

1. A sheet conveyance apparatus comprising:
a first conveyance unit configured to convey a sheet;
a second conveyance unit disposed downstream of the first conveyance unit in a sheet conveyance direction by the first conveyance unit, the second conveyance unit including a first roller and a second roller, the first roller and the second roller being configured to convey the sheet while nipping the sheet, the second conveyance unit being configured to convey the sheet in a first conveyance direction and subsequently convey the sheet in a second conveyance direction opposite to the first conveyance direction in a state in which the first roller and the second roller are in contact with the sheet;
a first conveyance path configured to guide the sheet that is conveyed from the first conveyance unit to the second conveyance unit;
a second conveyance path connected to the first conveyance path at a first connection portion, the second conveyance path being configured to guide the sheet that is conveyed in the second conveyance direction by the second conveyance unit;
a drive unit configured to drive the first conveyance unit and the second conveyance unit; and
a control unit configured to control the drive unit,
wherein, in a case where a preceding sheet is conveyed from the second conveyance unit to the second conveyance path and a succeeding sheet is conveyed to the first conveyance path, the control unit is configured to control the drive unit such that a leading edge of the succeeding sheet reaches the first connection portion in a state in which a trailing edge of the preceding sheet is positioned between the first connection portion and the second conveyance unit.

2. The sheet conveyance apparatus according to claim 1,
wherein, in a case where the first roller is rotated in a first rotational direction in a state in which the first roller and the second roller are in contact with the sheet, the second conveyance unit is configured to convey the sheet in the first conveyance direction, and, in a case where the first roller is rotated in a second rotational direction opposite to the first rotational direction in a state in which the first roller and the second roller are in contact with the sheet, the second conveyance unit is configured to convey the sheet in the second conveyance direction.

3. The sheet conveyance apparatus according to claim 1, further comprising:
a third conveyance path connected to the first conveyance path at a second connection portion disposed between the first conveyance unit and the first connection portion; and
a third conveyance unit configured to convey the sheet that has been guided to the third conveyance path.

4. The sheet conveyance apparatus according to claim 3,
further comprising a switching member that is switchable between a first position where the sheet conveyed to the second connection portion is guided to the second conveyance unit and a second position where the sheet conveyed to the second connection portion is guided to the third conveyance path.

5. The sheet conveyance apparatus according to claim 4,
wherein the switching member positioned at the second position is configured to guide the sheet, which is conveyed by the second conveyance unit in the second conveyance direction, to the second conveyance path.

6. The sheet conveyance apparatus according to claim 5,
further comprising a driven rotary member disposed in the switching member and configured to be rotated by coming into contact with the sheet.

7. The sheet conveyance apparatus according to claim 3, further comprising:
an apparatus body; and
a sheet discharge portion on which the sheet discharged from the apparatus body is stacked,
wherein the third conveyance path is configured to guide the sheet toward the sheet discharge portion.

8. The sheet conveyance apparatus according to claim 1,
further comprising a driven rotary member disposed between the first conveyance unit and the second conveyance unit, the driven rotary member being configured to be rotated by coming into contact with a surface on a side opposite to the second conveyance path of the sheet guided along the first conveyance path.

9. The sheet conveyance apparatus according to claim 1,
wherein the control unit is
configured to control the drive unit such that, when the leading edge of the succeeding sheet reaches the first connection portion, the preceding sheet is in a stopped state.

10. The sheet conveyance apparatus according to claim 1,
wherein the control unit is
configured to control the drive unit such that, when the leading edge of the succeeding sheet reaches the first connection portion, conveyance of the preceding sheet is maintained.

11. The sheet conveyance apparatus according to claim 4,
wherein the second conveyance path includes:
a first linear portion that extends linearly from the first connection portion in a direction of a virtual line connecting a nip portion of the first roller and the second roller and the first connection portion in a widthwise view perpendicular to the conveyance direction and is configured to guide the sheet; and
a curved portion that communicates with the first linear portion and is configured to guide the sheet by extending in a curved configuration that curves toward an intersecting direction intersecting the virtual line in the widthwise view,
wherein the first linear portion is formed between a conveyance guide including a guide surface and the switching member in the intersecting direction, and
wherein, in the widthwise view, the guide surface includes a concave configuration formed in an arcuate configuration recessed with respect to the virtual line in a direction opposite to the intersecting direction.

12. The sheet conveyance apparatus according to claim 11,
wherein the second conveyance path includes a second linear portion that communicates with the curved portion and is configured to guide the sheet by extending linearly from the curved portion in the intersecting direction, and
wherein the sheet conveyance apparatus includes a fourth conveyance unit configured to convey the sheet that has been guided to the second linear portion.

13. An image forming apparatus comprising:
the sheet conveyance apparatus according to claim 1; and
an image forming unit configured to form an image on the sheet.

14. The image forming apparatus according to claim 13,
further comprising a fixing unit configured to fix the image on the sheet on which the image has been formed by the image forming unit,
wherein the fixing unit includes a fixing roller, and
wherein the first conveyance unit includes the fixing roller.

15. The image forming apparatus according to claim 13,
wherein the second conveyance path is configured to guide the sheet, on whose first surface the image has been formed by the image forming unit, again toward the image forming unit.

16. The image forming apparatus according to claim 15,
wherein the control unit is configured to control the drive unit such that, when the leading edge of the succeeding sheet reaches the first connection portion, the image formed on the first surface of the preceding sheet has passed through the first connection portion.

17. The image forming apparatus according to claim 15, further comprising:
a sheet stacking portion;
a sheet feed unit configured to feed the sheet from the sheet stacking portion; and
a fourth conveyance path configured to guide the sheet conveyed from the sheet feed unit to the first conveyance unit,
wherein the second conveyance path is connected to the fourth conveyance path at a third connection portion disposed between the sheet feed unit and the image forming unit, and
wherein the control unit is configured to control the drive unit such that the leading edge of the preceding sheet reaches the third connection portion after the trailing edge of the succeeding sheet has passed through the third connection portion.
